(19) United States
(12) Patent Application Publication
(10) Pub. No.: US 2025/0134262 A1
(43) Pub. Date: May 1, 2025

(54) SEAT CUSHION

(71) Applicant: TOYOTA BOSHOKU KABUSHIKI KAISHA, Aichi-ken (JP)

(72) Inventors: Kosuke KITO, Toyota-shi (JP); Naoya HIRUKAWA, Nagoya-shi (JP)

(73) Assignee: TOYOTA BOSHOKU KABUSHIKI KAISHA, Aichi-ken (JP)

(21) Appl. No.: 18/921,557

(22) Filed: Oct. 21, 2024

(30) Foreign Application Priority Data
Oct. 27, 2023 (JP) 2023-184736

(51) Int. Cl. A47C 7/46; A47C 7/18

(52) U.S. Cl. CPC A47C 7/46; A47C 7/18

(57) ABSTRACT

A seat cushion includes a seat pad and a panel frame having a planar shape and configured to support the seat pad from a pad back side. The seat pad includes a pair of ischium supporting portions configured to support right and left ischia of a seated occupant, and a pair of recessed pad back recesses formed on pad back surfaces of the pair of ischium supporting portions. The panel frame includes a pair of release portions that are recessed toward a frame back side or form through holes directly below the pair of ischium supporting portions, and a first pad supporting portion configured to support the seat pad from the pad back side and disposed between the pair of release portions.

### CROSS REFERENCE TO RELATED APPLICATIONS

This application is based on Japanese Patent Applications No. 2023-184736 filed on Oct. 27, 2023, the entire contents of which are incorporated herein by reference.

### TECHNICAL FIELD

The present invention relates to a seat cushion. Specifically, the present invention relates to a seat cushion including a seat pad and a planar panel frame that supports the seat pad from a pad back side.

### BACKGROUND ART

JP2014-227137A discloses a seat cushion in which a seat pad is supported from a pad back side by a planar panel frame. In the seat pad, a recess for enhancing cushioning properties is formed on the pad back surface.

In the configuration described in JP2014-227137A, in a case in which a pad thickness of the seat pad cannot be secured due to restrictions such as thinning of the seat cushion, a bottom touching feeling is likely to occur in a supporting portion for an ischium, which receives a high pressure by seating. Therefore, the present invention provides a seat cushion that is less likely to cause a bottom touching feeling even if a pad thickness is thin.

### SUMMARY OF INVENTION

To solve the above matters, a seat cushion according to the present invention is configured as follows.

According to an aspect of the present disclosure, a seat cushion includes:
a seat pad; and
a panel frame having a planar shape and configured to support the seat pad from a pad back side, wherein
the seat pad includes a pair of ischium supporting portions configured to support right and left ischia of a seated occupant, and a pair of recessed pad back recesses formed on pad back surfaces of the pair of ischium supporting portions, and
the panel frame includes a pair of release portions that are recessed toward a frame back side or form through holes directly below the pair of ischium supporting portions, and a first pad supporting portion configured to support the seat pad from the pad back side and disposed between the pair of release portions.

According to the first aspect of the present invention, the left and right ischium supporting portions of the seat pad may be more easily deflected due to the left and right pad back recesses formed on the pad back surface of the seat pad. In addition, the release portions formed directly below the respective ischium supporting portions of the panel frame may prevent the respective ischium supporting portions of the seat pad from coming into contact with the panel frame even if the respective ischium supporting portions are deflected by a seating load. As a result, a bottom touching feeling may be made less likely to occur in each of the ischium supporting portions of the seat pad. Further, since the first pad supporting portion of the panel frame supports the seat pad from the pad back side between the respective ischium supporting portions, the respective ischium supporting portions of the seat pad may be prevented from bottoming out.

In the seat cushion according to the first aspect, the pair of release portions are the through holes.

According to the second aspect of the present invention, even when a sufficient space cannot be secured on the frame back side due to a restriction such as a battery being mounted directly below the panel frame, the pair of release portions may be appropriately provided in the panel frame.

In the seat cushion according to the first or second aspect, the panel frame further includes a pair of second pad supporting portions configured to support, from the pad back side, a pair of side supporting portions that are deviated outward in a seat width direction from the pair of pad back recesses of the seat pad.

According to the third aspect of the present invention, the side supporting portions of the seat pad are supported from the pad back side by the pair of second pad supporting portions of the panel frame, thereby making it possible to implement the seat pad in a manner that the seat pad is less likely to wobble from side to side.

In the seat cushion according to the third aspect, each of the release portions formed in the panel frame is positioned inside a corresponding one of the pad back recesses formed in the seat pad in a plan view.

According to the fourth aspect of the present invention, the pad back surface of the seat pad may be appropriately prevented from rubbing against a peripheral edge of each of the release portions of the panel frame.

### BRIEF DESCRIPTION OF DRAWINGS

FIG. 1 is a perspective view illustrating a schematic configuration of a seat cushion according to a first embodiment;

FIG. 2 is an exploded perspective view in which a seat pad is removed from a panel frame;

FIG. 3 is a bottom view of the seat cushion;

FIG. 4 is a cross-sectional view taken along a line IV-IV in FIG. 3; and

FIG. 5 is a cross-sectional view corresponding to FIG. 4, illustrating a state in which the seat pad is deflected when being seated.

### DESCRIPTION OF EMBODIMENTS

Hereinafter, an embodiment of the present invention will be described with reference to the drawings.

### First Embodiment

### (Schematic Configuration of Seat Cushion 1)

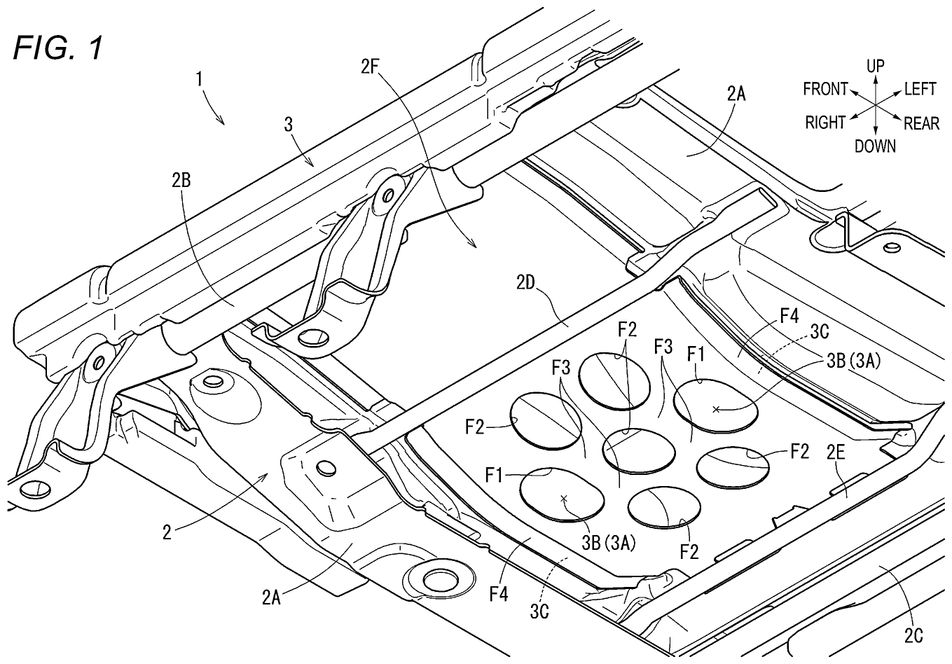

First, a configuration of a seat cushion 1 according to a first embodiment of the present invention will be described with reference to FIGS. 1 to 5. In the following description, when a direction such as front, rear, up, down, left, or right is described, it is assumed that the direction indicates a corresponding direction illustrated in the drawings.

When combinations of the directions with a word “seat” are described such as a “seat width direction”, the combinations indicate directions based on the seat cushion 1. In addition, in the following description, when a specific reference diagram is not described or when there is no corresponding reference numeral in the reference diagram, any one of FIGS. 1 to 5 is referred to as appropriate.

As illustrated in FIG. 1, the seat cushion 1 according to the present embodiment is implemented as a seating portion for a rear seat of an automobile. The seat cushion 1 is installed on a floor of an automobile (not illustrated). The seat cushion 1 includes a metal seat frame 2 that forms a framework of the seat cushion 1, a seat pad 3 made of foamed urethane that is installed on an upper portion of the seat frame 2, and a seat cover (not illustrated) that covers the seat pad 3 from a pad front surface side.

The seat frame 2 includes a pair of left and right long plate-shaped side frames 2A extending in a seat front-rear direction along left and right side portions of the seat cushion 1. The seat frame 2 includes a round pipe-shaped front pipe 2B extending in the seat width direction along a front side portion of the seat cushion 1. The seat frame 2 includes a round pipe-shaped rear pipe 2C extending in the seat width direction along a rear side portion of the seat cushion 1.

The front pipe 2B is connected in a manner of being bridged in the seat width direction between front end portions of the pair of left and right side frames 2A. The rear pipe 2C is connected in a manner of being bridged in the seat width direction between rear end portions of the pair of left and right side frames 2A.

The seat frame 2 includes a front rod 2D and a rear rod 2E each having a round pipe shape and connected in a manner of being bridged in the seat width direction between intermediate portions of the pair of left and right side frames 2A in the seat front-rear direction. As described above, the seat frame 2 is implemented to be assembled in a ladder shape in a plan view.

The seat frame 2 includes a panel frame 2F that is rectangular in a plan view and is connected in a manner of being bridged in the seat front-rear direction between the front pipe 2B and the rear rod 2E. The panel frame 2F is welded in a manner that a front edge portion thereof comes into contact with the front pipe 2B from above and a rear edge portion thereof comes into contact with the rear rod 2E from above.

The panel frame 2F is welded in a manner that an intermediate portion thereof in the seat front-rear direction comes into contact with the front rod 2D from above. Accordingly, the panel frame 2F is supported from a frame back side over an entire region in the seat width direction at three positions in the seat front-rear direction by three members of the front pipe 2B, the front rod 2D, and the rear rod 2E.

The seat frame 2 functions as a pad receiving portion that supports the seat pad 3 installed on the seat frame 2 from a pad back side. Specifically, the seat frame 2 supports side parts (both side parts in the seat width direction) of the seat pad 3 from the pad back side by the pair of left and right side frames 2A.

The seat frame 2 supports a main part (a central part in the seat width direction) of the seat pad 3 from the pad back side by the panel frame 2F. Specifically, the panel frame 2F supports a hip portion and thighs of a seated occupant from the pad back side in a planar manner via the seat pad 3.

The seat frame 2 is implemented in a manner that a battery mounted on a floor (not illustrated) is disposed adjacent to and directly below the panel frame 2F. Therefore, by the panel frame 2F which is less likely to deflect as compared with a spring, the seat frame 2 rigidly supports the seat pad 3 in a manner of minimizing deflecting of the seat pad 3 toward the frame back side.

However, if the support of the seat pad 3 provided by the seat frame 2 is too rigid over the entire region, a bottom touching feeling is likely to occur particularly in a supporting portion for an ischium, which receives a high pressure by seating. Such a matter becomes more pronounced when a pad thickness of the seat pad 3 cannot be sufficiently secured as the seat cushion 1 becomes thinner.

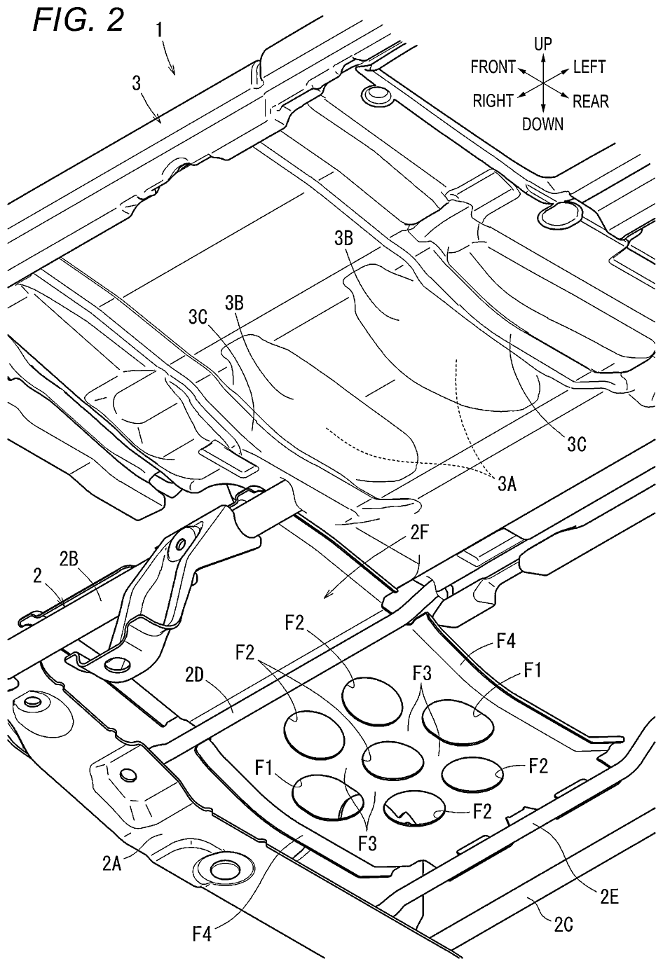

Therefore, in order to reduce the bottom touching feeling, the seat pad 3 and the panel frame 2F are structured in a manner of being capable of reducing the bottom touching feeling even if the pad thickness is thin. Specifically, as illustrated in FIGS. 2 to 4, in the seat pad 3, pad back recesses 3B recessed in a recessed shape are formed on pad back surfaces of a pair of ischium supporting portions 3A supporting right and left ischia of the seated occupant.

These pad back recesses 3B are not only formed in positions corresponding to the pad back surfaces of the left and right ischium supporting portions 3A, but also extend in a longitudinal oval shape beyond the left and right ischium supporting portions 3A in the seat front-rear direction. The pad back recesses 3B are recessed into a concave curved surface in cross section. Specifically, these pad back recesses 3B are deepest at positions corresponding to the pad back surfaces of the right and left ischium supporting portions 3A, and become gradually shallower as these pad back recesses 3B extend from the positions corresponding to the pad back surfaces in the seat front-rear direction.

The panel frame 2F is formed with, at positions directly below the left and right ischium supporting portions 3A of the seat pad 3, a pair of left and right through holes F1 each penetrating in a manner of extending in an elongated round hole shape in a front-rear direction.

Here, each of the through holes F1 corresponds to a “release portion” of the present invention. In addition to the through holes F1, the panel frame 2F is formed with a plurality of round hole-shaped reduction holes F2 for reducing a mass so as not to affect the performance of the panel frame 2F. Each of the through holes F1 has an elongated round hole shape that is longer than each of the reduction holes F2 in the front-rear direction.

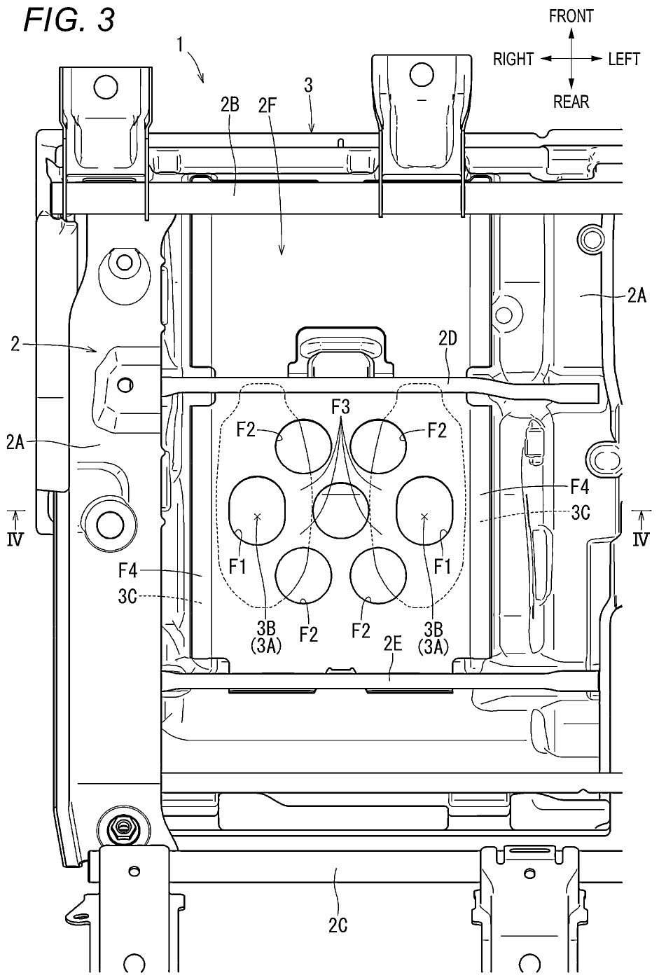

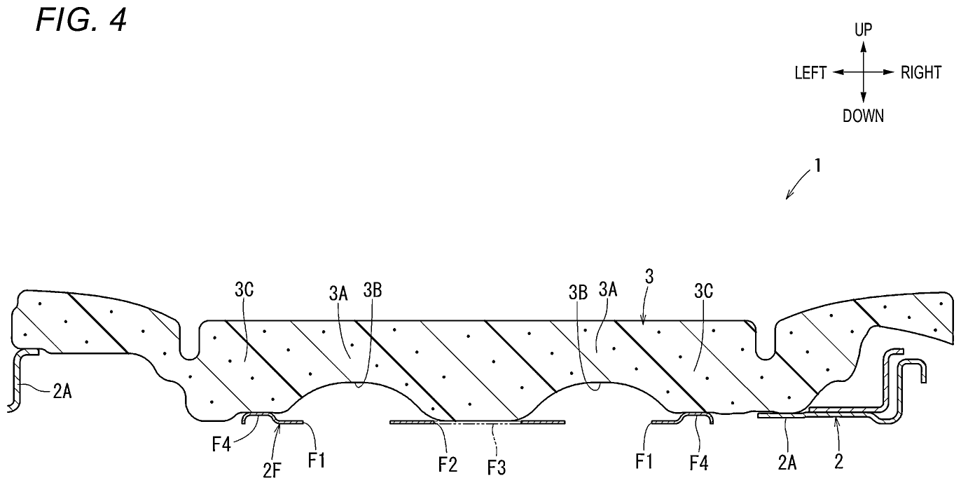

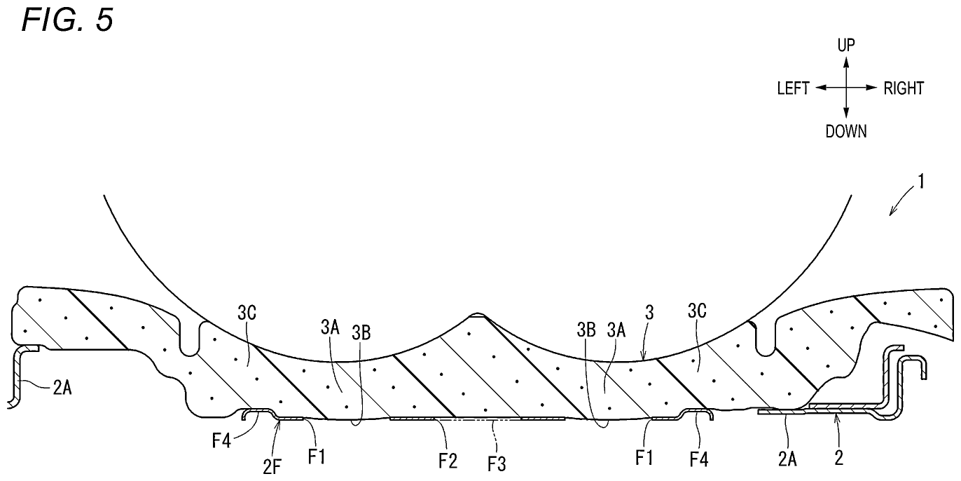

As illustrated in FIGS. 3 and 4, with the above configuration, when the seat pad 3 receives a seating load from the pad front surface side, the right and left ischium supporting portions 3A are easily deflected toward the pad back side. Specifically, as illustrated in FIG. 5, when the seat pad 3 receives a seating load from the pad front surface side, the left and right ischium supporting portions 3A are deflected in a manner of crushing the recesses of the pad back recesses 3B toward the pad back side.

The through holes F1 formed in the panel frame 2F are disposed directly below the left and right ischium supporting portions 3A of the seat pad 3. Therefore, even if the left and right ischium supporting portions 3A of the seat pad 3 receive the seating load and are deflected toward the pad back side, the left and right ischium supporting portions 3A are pulled out to the seat lower side from the respective through holes F1 without coming into contact with the panel frame 2F. As a result, the bottom touching feeling may be made less likely to occur in each of the ischium supporting portions 3A of the seat pad 3.

Specifically, as illustrated in FIG. 2, in the seat pad 3, the left and right pad back recesses 3B are not connected to each other and are separated from each other in a left-right direction. Therefore, as illustrated in FIG. 3, a portion of the seat pad 3 between the left and right ischium supporting portions 3A is supported from the pad back side by a first pad supporting portion F3 between the through holes F1 of the panel frame 2F. The support provided by the first pad supporting portion F3 may prevent the ischium supporting portions 3A of the seat pad 3 from bottoming out.

As illustrated in FIG. 4, left and right side supporting portions 3C of the seat pad 3, which are deviated outward in the seat width direction from the left and right pad back recesses 3B, are supported from the pad back side by left and right second pad supporting portions F4, which are deviated outward in the seat width direction from the left and right through holes F1 of the panel frame 2F. Therefore, the seat pad 3 may be implemented in a manner of being less likely to wobble from side to side.

As illustrated in FIG. 3, the pair of through holes F1 formed in the panel frame 2F are arranged in a manner of being accommodated in formation regions of the pair of pad back recesses 3B formed in the seat pad 3 in a plan view. Therefore, the pad back surface of the seat pad 3 may be appropriately prevented from rubbing against a peripheral edge of each of the through holes F1 of the panel frame 2F.

To summarize the above, the seat cushion 1 according to the present embodiment may have the following configuration. In the following description, reference numerals assigned in parentheses correspond to the configurations described in the embodiment described above.

That is, a seat cushion (1) includes: a seat pad (3); and a planar panel frame (2F) configured to support the seat pad (3) from a pad back side. The seat pad (3) includes a pair of ischium supporting portions (3A) configured to support right and left ischia of a seated occupant, and a pair of recessed pad back recesses (3B) formed on pad back surfaces of the pair of ischium supporting portions (3A). The panel frame (2F) includes a pair of release portions (F1) that are recessed toward a frame back side or form through holes (F1) directly below the pair of ischium supporting portions (3A), and a first pad supporting portion (F3) configured to support the seat pad (3) from the pad back side between the pair of release portions (F1).

According to the above configuration, the left and right ischium supporting portions (3A) of the seat pad (3) may be more easily deflected due to the left and right pad back recesses (3B) formed on the pad back surface of the seat pad (3). In addition, the release portions (F1) formed directly below the respective ischium supporting portions (3A) of the panel frame (2F) may prevent the respective ischium supporting portions (3A) of the seat pad (3) from coming into contact with the panel frame (2F) even if the respective ischium supporting portions (3A) are deflected by the seating load. As a result, the bottom touching feeling may be made less likely to occur in each of the ischium supporting portions (3A) of the seat pad (3). Further, since the first pad supporting portion (F3) of the panel frame (2F) supports the seat pad (3) from the pad back side between the respective ischium supporting portions (3A), the respective ischium supporting portions (3A) of the seat pad (3) may be prevented from bottoming out.

The pair of release portions (F1) are the through holes (F1). According to the above configuration, even when a sufficient space cannot be secured on the frame back side due to a restriction such as a battery being mounted directly below the panel frame (2F), the pair of release portions (F1) may be appropriately provided in the panel frame (2F).

The panel frame (2F) further includes a pair of second pad supporting portions (F4) configured to support, from the pad back side, a pair of side supporting portions (3C) that are deviated outward in a seat width direction from the pair of pad back recesses (3B) of the seat pad (3). Accordingly, the side supporting portions (3C) of the seat pad (3) are supported from the pad back side by the pair of second pad supporting portions (F4) of the panel frame (2F), thereby making it possible to implement the seat pad (3) in a manner that the seat pad (3) is less likely to wobble from side to side.

The pair of release portions (F1) formed in the panel frame (2F) are arranged in a manner of being accommodated in formation regions of the pair of pad back recesses (3B) formed in the seat pad (3) in a plan view. According to the above configuration, the pad back surface of the seat pad (3) may be appropriately prevented from rubbing against a peripheral edge of each of the release portions (F1) of the panel frame (2F).

<Other Embodiments> The embodiments according to the present invention have been described with reference to one embodiment, whereas the present invention may be implemented in various forms other than the above embodiment.
1. The seat cushion according to the present invention is applicable not only to a seat to be mounted on a vehicle such as an automobile or a railroad vehicle, but also to a seat to be mounted on other vehicles such as an aircraft or a ship. The seat cushion is also applicable to a seat not to be mounted on a vehicle.
2. The recessed shape of the pair of pad back recesses formed on the pad back surface of the seat pad may be recessed in a curved surface shape in addition to being recessed into a concave curved surface. Each of the pair of pad back recesses may be implemented by a plurality of recesses in addition to being implemented by a single recess.
3. The pair of release portions formed in the panel frame may be implemented by recesses each recessed toward the frame back side, in addition to the through holes. The pair of release portions may be formed beyond formation regions of the pair of pad back recesses formed in the seat pad in a plan view. By forming the pair of release portions beyond the formation regions of the pair of pad back recesses in a plan view, contact with each of the ischium supporting portions of the seat pad may be prevented in a wider range.

What is claimed is:

1. A seat cushion, comprising:
a seat pad; and
a panel frame having a planar shape and configured to support the seat pad from a pad back side, wherein
the seat pad includes a pair of ischium supporting portions configured to support right and left ischia of a seated occupant, and a pair of recessed pad back recesses formed on pad back surfaces of the pair of ischium supporting portions, and
the panel frame includes a pair of release portions that are recessed toward a frame back side or form through holes directly below the pair of ischium supporting portions, and a first pad supporting portion configured to support the seat pad from the pad back side and disposed between the pair of release portions.

2. The seat cushion according to claim 1, wherein
the pair of release portions are the through holes.

3. The seat cushion according to claim 1, wherein
the panel frame further includes a pair of second pad supporting portions configured to support, from the pad back side, a pair of side supporting portions that are deviated outward in a seat width direction from the pair of pad back recesses of the seat pad.

4. The seat cushion according to claim 1, wherein
each of the release portions formed in the panel frame is positioned inside a corresponding one of the pad back recesses formed in the seat pad in a plan view.

5. The seat cushion according to claim 2, wherein
the panel frame further includes a pair of second pad supporting portions configured to support, from the pad back side, a pair of side supporting portions that are deviated outward in a seat width direction from the pair of pad back recesses of the seat pad.

6. The seat cushion according to claim 2, wherein
each of the release portions formed in the panel frame is positioned inside a corresponding one of the pad back recesses formed in the seat pad in a plan view.
